(19) United States
(12) Patent Application Publication
(10) Pub. No.: US 2020/0175384 A1
(43) Pub. Date: Jun. 4, 2020

(54) SYSTEM AND METHOD FOR INCREMENTAL LEARNING

(71) Applicant: Samsung Electronics Co., Ltd., Suwon-si (KR)

(72) Inventors: Junting Zhang, Los Angeles, CA (US); Jie Zhang, San Jose, CA (US); Shalini Ghosh, Menlo Park, CA (US); Dawei Li, San Jose, CA (US); Serafettin Tasci, Sunnyvale, CA (US); Larry Heck, Los Altos, CA (US)

(21) Appl. No.: 16/255,737

(22) Filed: Jan. 23, 2019

Related U.S. Application Data
(60) Provisional application No. 62/773,499, filed on Nov. 30, 2018.
(60) Provisional application No. 62/784,247, filed on Dec. 21, 2018.

(51) Int. Cl. G06N 5/02; G06N 20/00

(52) U.S. Cl. CPC G06N 5/02; G06N 20/00

(57) ABSTRACT

Methods, devices, and computer-readable media for incremental learning in image classification and/or object detection. A method for incremental learning includes identifying, for a model for object detection or classification, a first set of object classes the model is trained to detect or classify and adapting the model for use with a second set of object classes different from the first set of object classes to generate an adapted model. The method further includes retaining detection or classification performance on the first set of object classes in the adapted model by performing a knowledge distillation process for the model; and using the adapted model to detect or classify one or more objects from the first set of object classes and one or more objects from the second set of object classes.

### CROSS-REFERENCE TO RELATED APPLICATION AND CLAIM OF PRIORITY

This application claims the benefit under 35 U.S.C. § 119(e) of U.S. Provisional Patent Application No. 62/773,499 filed on Nov. 30, 2018 and U.S. Provisional Patent Application No. 62/784,247 filed on Dec. 21, 2018. The above-identified provisional patent application is hereby incorporated by reference in its entirety.

### TECHNICAL FIELD

Embodiments of the present disclosure relate generally to deep learning. More specifically, various embodiments of the present disclosure relate to incremental learning (IL) without forgetting.

### BACKGROUND

Object recognition and detection is a classic and fundamental computer vision problem. It is critical to many applications, such as video surveillance, self-driving cars, and crowd counting, etc. Despite the recent success of deep learning in computer vision for a broad range of tasks, classical training paradigm of deep models is ill-equipped for IL. Traditionally, most deep neural networks used in intelligent vision system can only be trained in a batch mode, in which data is given prior to training, and all classes are known in advance.

However, the real-world is dynamic and there are new objects of interest emerging over time. Re-training a model from scratch whenever a new class is encountered is prohibitively expensive due to the huge data storage requirements and computational cost. Directly fine-tuning the existing model on only the data of new classes using stochastic gradient descent (SGD) optimization is not a better approach either, as this might lead to the notorious catastrophic forgetting effect, which refers to the severe performance degradation on old tasks. In a life-long learning system, where the underlying system learns about new objects over time, it is desired to have the object detectors incrementally learn about new classes when training data for them becomes available.

### SUMMARY

The embodiments of the present disclosure provide for IL without forgetting for efficient object detection.

In one embodiment, a method for IL is provided. The method includes identifying, via a model for object detection or classification, a first set of object classes the model is trained to detect or classify and adapting the model for use with a second set of object classes different from the first set of object classes to generate an adapted model. The method further includes retaining detection or classification performance on the first set of object classes in the adapted model by performing a knowledge distillation process for the model; and using the adapted model to detect one or more objects from the first set of object classes and one or more objects from the second set of object classes.

In another embodiment, an electronic device for IL is provided. The electronic device includes a memory configured to store a model for object detection or classification and a processor operably connected to the memory. The processor is configured to identify, via the model for object detection or classification, a first set of object classes the model is trained to detect or classify and adapt the model for use with a second set of object classes different from the first set of object classes to generate an adapted model. The processor is further configured to retain detection or classification performance on the first set of object classes in the adapted model by performing a knowledge distillation process for the model and use the adapted model to detect or classify one or more objects from the first set of object classes and one or more objects from the second set of object classes.

In yet another embodiment, a non-transitory, computer-readable medium comprising program code for IL is provided. The program code, when executed by a processor of an electronic device, causes the electronic device to identify, via a model for object detection, a first set of object classes the model is trained to detect and adapt the model for use with a second set of object classes different from the first set of object classes to generate an adapted model. The program code, when executed by a processor of an electronic device, further causes the electronic device to retain detection or classification performance on the first set of object classes in the adapted model by performing a knowledge distillation process for the model and use the adapted model to detect one or more objects from the first set of object classes and one or more objects from the second set of object classes.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example computing system according to this disclosure;

FIGS. 2 and 3 illustrate example devices in a computing system in accordance with an embodiment of this disclosure;

FIG. 4 illustrates an example of a system to implement a method for adapting an existing model to implement IL without forgetting for efficient object detection or classification in accordance with various embodiment of the present disclosure;

FIG. 5A illustrates an example of a diagram of another method for adapting an existing model to implement IL without forgetting for efficient image classification in accordance with various embodiment of the present disclosure;

FIG. 5B illustrates an example of a diagram of another method for adapting an existing model to implement IL without forgetting for efficient object detection in accordance with various embodiment of the present disclosure;

FIGS. 6A and 6B illustrate example class detectors in accordance with various embodiments of the present disclosure;

FIG. 7 illustrates an example diagram for a knowledge distillation process in generating a combined model in accordance with various embodiments of the present disclosure;

FIG. 8 illustrates a flowchart of a process for an implementation of IL without forgetting in accordance with various embodiments of the present disclosure;

FIG. 9 illustrates a flowchart of a process for another implementation of IL without forgetting in accordance with various embodiments of the present disclosure;

FIG. 10 illustrates an example of a diagram of a system for adapting an existing model to implement IL without forgetting in accordance with various embodiment of the present disclosure; and

FIG. 11 illustrates a flowchart of a process for IL in accordance with various embodiments of the present disclosure.

### DETAILED DESCRIPTION

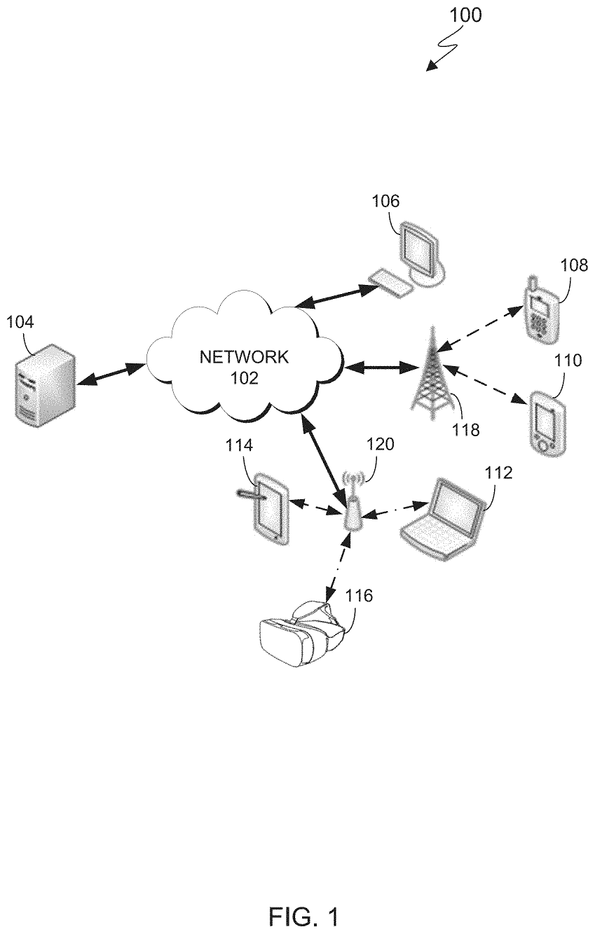

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

Embodiments of the present disclosure recognize that deep neural networks (DNNs) often suffer from an abrupt degradation of performance on the original set of classes when the training objective is adapted to a newly added set of classes as part of IL. This phenomenon is sometimes referred to as “catastrophic forgetting.” Embodiments of the present disclosure further recognize that some IL approaches attempting to overcome catastrophic forgetting tend to produce a model that is biased towards either the old classes or new classes, unless with the help of exemplars of the old data.

Accordingly, various embodiments of the present disclosure provide a class-IL paradigm called deep model consolidation (DMC), which can even work well when the original training data is not available. Various embodiments of the present disclosure further provide methods that can train state-of-the-art object detector in a class-incremental fashion.

Embodiments of the present disclosure recognize that, for class-based IL, the original training data for old classes may no longer be accessible when learning new classes. This could be due to a variety of reasons, e.g., legacy data may be unrecorded, proprietary, too large to store, or simply too difficult to use in training the model for a new task. Embodiments of the present disclosure further recognize that the class-based IL system should continue to provide a competitive multi-class classifier for the classes observed so far and that the model size should remain approximately the same after learning new classes.

To eliminate such intrinsic bias caused by the information asymmetry or over-regularization in the training, various embodiments utilize a dual distillation training objective function process, such that a student model can learn from two teacher models simultaneously. To overcome the difficulty introduced by loss of access to legacy data, various embodiments provide a method that leverages publicly available data, where the abundant transferable representations are mined to facilitate IL. Accordingly, in some embodiments, a class-IL for DMC is utilized, which first trains an individual new model for the new classes using labeled data, and then combines the new model with the existing model using unlabeled auxiliary data via a dual distillation training process. For example, the auxiliary data may not share the class labels or generative distribution of the target data. Usage of such unlabeled data incurs no additional dataset construction and maintenance cost since it can be crawled from the web effortlessly when needed and discarded once the IL of new classes is complete. Furthermore, the symmetric role of the two teacher models in DMC has a valuable extra benefit in generalization; this can be directly applied to combine any two arbitrary pretrained models for easy deployment (e.g., only one model needs to be deployed instead of two) and access to the original training data for either of the two models is not required.

Accordingly, one or more embodiments of the present disclosure provide IL for image classification to modify a classifier on new images to learn a new image class; architectural techniques to expand the model for a new task and then compress the model to maintain the model complexity; regularization techniques to use criteria (e.g., pruning criteria) to identify the important weights for the old classes; rehearsal-based techniques to use an extra memory unit to store a small amount of old data; and/or IL for object detection to detect new objects by modifying an existing object detection model. In some embodiments, the present disclosure provides a method for IL that uses external unlabeled data, which can be obtained at negligible cost; a training objective function to combine two deep models into one single compact model to promote symmetric knowledge transfer where these two models can have different architectures and be trained on data of distinct set of classes; and/or an extension of this method for IL to incrementally train modern one-stage object detectors.

FIG. 1 illustrates an example computing system 100 according to the present disclosure. The embodiment of the system 100 shown in FIG. 1 is for illustration only. Other embodiments of the system 100 can be used without departing from the scope of the present disclosure.

In this illustrative example, the computing system 100 is a system in which the IL methods of the present disclosure may be implemented. The system 100 includes network 102 that facilitates communication between various components in the system 100. For example, network 102 can communicate Internet Protocol (IP) packets, frame relay frames, or other information between network addresses. The network 102 includes one or more local area networks (LANs), metropolitan area networks (MANs), wide area networks (WANs), all or a portion of a global network such as the Internet, or any other communication system or systems at one or more locations.

The network 102 facilitates communications between a server 104 and various client devices 106-116. The client devices 106-116 may be, for example, a smartphone, a tablet computer, a laptop, a personal computer, a wearable device, or a head-mounted display (HMD). The server 104 can represent one or more servers. Each server 104 includes any suitable computing or processing device that can provide computing services for one or more client devices. Each server 104 could, for example, include one or more processing devices, one or more memories storing instructions and data, and one or more network interfaces facilitating communication over the network 102. As described in more detail below, in various embodiments, the server 104 may train models for IL without forgetting for efficient object detection and/or classification. In other embodiments, the server 104 may be a webserver to provide or access deep learning networks, training data, and/or any other information to implement IL embodiments of the present discus lure.

Each client device 106-116 represents any suitable computing or processing device that interacts with at least one server or other computing device(s) over the network 102. In this example, the client devices 106-116 include a desktop computer 106, a mobile telephone or mobile device 108 (such as a smartphone), a personal digital assistant (PDA) 110, a laptop computer 112, a tablet computer 114, and an HMD 116. However, any other or additional client devices could be used in the system 100. As described in more detail below, each client device 106-116 may train models for IL without forgetting for efficient object detection and/or classification.

In this example, some client devices 108-116 communicate indirectly with the network 102. For example, the client devices 108 and 110 (mobile devices 108 and PDA 110, respectively) communicate via one or more base stations 118, such as cellular base stations or eNodeBs (eNBs). Mobile device 108 includes smartphones. Also, the client devices 112, 114, and 116 (laptop computer, tablet computer, and HMD, respectively) communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

Although FIG. 1 illustrates one example of a system 100, various changes can be made to FIG. 1. For example, the system 100 could include any number of each component in any suitable arrangement. In general, computing and communication systems come in a wide variety of configurations, and FIG. 1 does not limit the scope of the present disclosure to any particular configuration. While FIG. 1 illustrates one operational environment in which various features disclosed in this patent document can be used, these features could be used in any other suitable system.

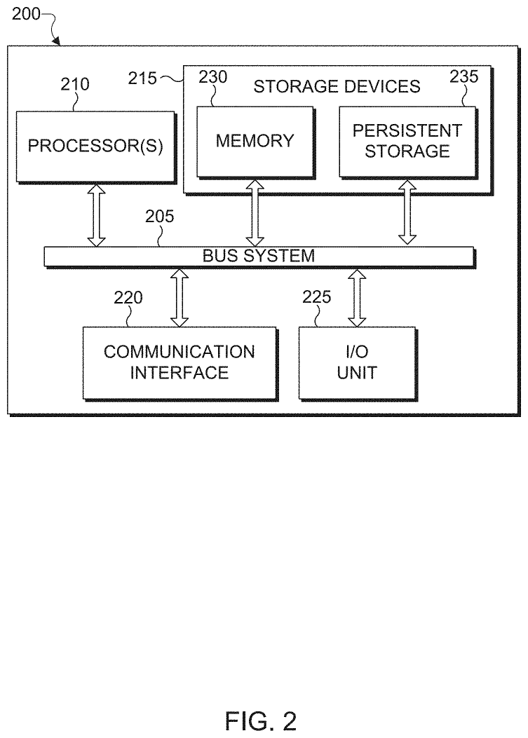

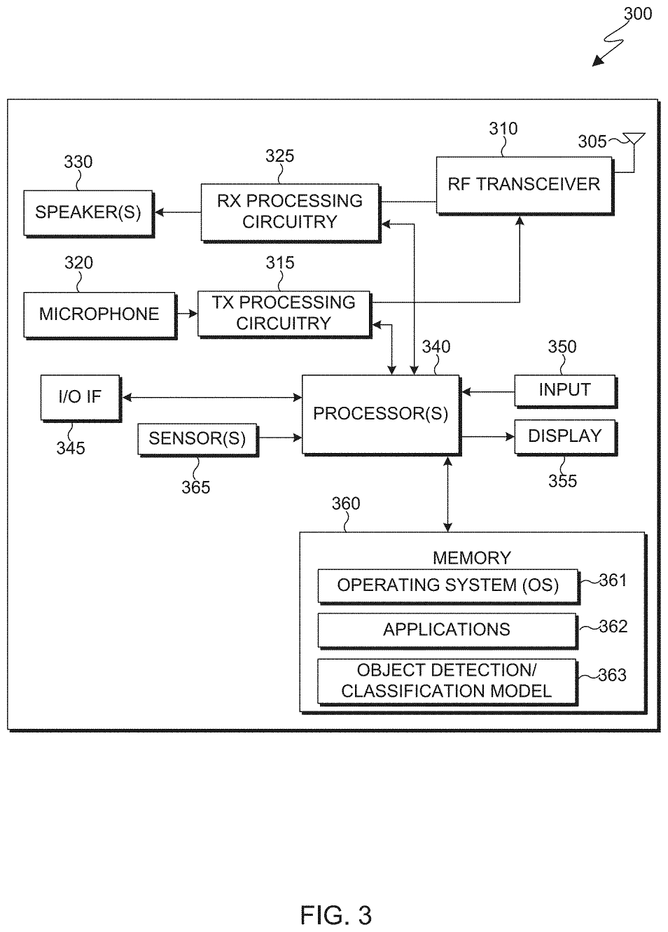

FIGS. 2 and 3 illustrate example devices in a computing system in accordance with various embodiments of the present disclosure. In particular, FIG. 2 illustrates an example electronic device 200, and FIG. 3 illustrates an example electronic device 300. The electronic device 200 could represent the server 104 of FIG. 1, and the electronic device 300 could represent one or more of the client devices 106-116 of FIG. 1. The embodiments of the electronic devices 200 and 300 shown in FIGS. 2 and 3 are for illustration only, and other embodiments could be used without departing from the scope of the present disclosure. The electronic devices 200 and 300 can come in a wide variety of configurations, and FIG. 2 or 3 do not limit the scope of the present disclosure to any particular implementation of an electronic device.

Electronic device 200 can represent one or more servers or one or more personal computing devices. As shown in FIG. 2, the electronic device 200 includes a bus system 205 that supports communication between at least one processor(s) 210, at least one storage device(s) 215, at least one communications interface 220, and at least one input/output (I/O) unit 225.

The processor 210 executes instructions that can be stored in a memory 230. The instructions stored in memory 230 can include instructions for generating and/or modifying model for object detection and/or or classification to provide for IL without forgetting. The processor 210 can include any suitable number(s) and type(s) of processors or other devices in any suitable arrangement. Example types of processor(s) 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random-access memory or any other suitable volatile or non-volatile storage device(s). The persistent storage 235 can contain one or more components or devices supporting longer-term storage of data, such as a ready-only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). The I/O unit 225 allows for input and output of data. For example, the I/O unit 225 can provide a connection for user input through a keyboard, mouse, keypad, touchscreen, motion sensors, or any other suitable input device. The I/O unit 225 can also send output to a display, printer, or any other suitable output device.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

The electronic device 300 can be any personal computing device, such as, for example, a wireless terminal, a desktop computer (similar to desktop computer 106 of FIG. 1), a mobile device (similar to mobile device 108 of FIG. 1), a PDA (similar to PDA 110 of FIG. 1), a laptop (similar to laptop computer 112 of FIG. 1), a tablet (similar to tablet computer 114 of FIG. 1), a head-mounted display (similar to HMD 116 of FIG. 1), and the like.

As shown in FIG. 3, the electronic device 300 includes an antenna 305, a radio-frequency (RF) transceiver 310, a transmit (TX) processing circuitry 315, a microphone 320, and a receive (RX) processing circuitry 325. The electronic device 300 also includes a speaker 330, a one or more processors 340, an input/output (I/O) interface (IF) 345, an input 350, a display 355, and a memory 360. The memory 360 includes an operating system (OS) 361, one or more applications 362, and object detection model(s) 363.

The RF transceiver 310 receives, from the antenna 305, an incoming RF signal transmitted by another component on a system. For example, the RF transceiver 310 receives RF signal transmitted by a BLUETOOTH or WI-FI signal from an access point (such as a base station, WI-FI router, BLUETOOTH device) of the network 102 (such as a WI-FI, BLUETOOTH, cellular, 5G, LTE, LTE-A, WiMAX, or any other type of wireless network). The RF transceiver 310 can down-convert the incoming RF signal to generate an intermediate frequency or baseband signal. The intermediate frequency or baseband signal is sent to the RX processing circuitry 325 that generates a processed baseband signal by filtering, decoding, or digitizing the baseband or intermediate frequency signal, or a combination thereof. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, digitizes, or a combination thereof, the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices and execute the OS 361 stored in the memory 360 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other applications 362 resident in the memory 360, such as for generating and/or modifying model for object detection and/or or classification to provide for IL without forgetting. The processor 340 can move data into or out of the memory 360 as required by an executing process. In some embodiments, the processor 340 is configured to execute the plurality of applications 362 based on the OS 361 or in response to signals received from eNBs (similar to the base stations 118 of FIG. 1) or an operator. The processor 340 is also coupled to the I/O IF 345 that provides the electronic device 300 with the ability to connect to other devices, such as client devices 106-116. The I/O IF 345 is the communication path between these accessories and the processor 340.

The processor 340 is also coupled to the input 350. The operator of the electronic device 300 can use the input 350 to enter data or inputs into the electronic device 300. Input 350 can be a keyboard, touch screen, mouse, track-ball, voice input, or any other device capable of acting as a user interface to allow a user in interact with electronic device 300. For example, the input 350 can include voice recognition processing thereby allowing a user to input a voice command via microphone 320. For another example, the input 350 can include a touch panel, a (digital) pen sensor, a key, or an ultrasonic input device. The touch panel can recognize, for example, a touch input in at least one scheme among a capacitive scheme, a pressure sensitive scheme, an infrared scheme, or an ultrasonic scheme.

The processor 340 is also coupled to the display 355. The display 355 can be a liquid crystal display (LCD), light-emitting diode (LED) display, organic LED (OLED), active matrix OLED (AMOLED), or other display capable of rendering text and/or graphics, such as from websites, videos, games, images, and the like.

The memory 360 is coupled to the processor 340. Part of the memory 360 could include a random-access memory (RAM), and another part of the memory 360 could include a Flash memory or other read-only memory (ROM). The memory 360 can include persistent storage that represents any structure(s) capable of storing and facilitating retrieval of information (such as data, program code, and/or other suitable information on a temporary or permanent basis). The memory 360 can contain one or more components or devices supporting longer-term storage of data, such as a ready only memory, hard drive, Flash memory, or optical disc. In various embodiments, the electronic device 300 includes the object detection/classification model 363 for object detection and/or classification, which can be updated and/or modified to provide for IL without forgetting.

Electronic device 300 can further include one or more sensors 365 that meter a physical quantity or detect an activation state of the electronic device 300 and convert metered or detected information into an electrical signal. For example, sensor(s) 365 may include one or more buttons for touch input (located on the headset or the electronic device 300), one or more cameras, a gesture sensor, an eye tracking sensor, a gyroscope or gyro sensor, an air pressure sensor, a magnetic sensor or magnetometer, an acceleration sensor or accelerometer, a grip sensor, a proximity sensor, a color sensor (such as a Red Green Blue (RGB) sensor), a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an infrared (IR) sensor, an ultrasound sensor, an iris sensor, a fingerprint sensor, and the like. The sensor(s) 365 can further include a control circuit for controlling at least one of the sensors included therein.

For example, in various embodiments, the camera in in the sensor(s) 365 may be used to capture images and/or videos of objects for object detection and/or classification to implement IL without forgetting. In other embodiments, the microphone 320 may be used to capture voice inputs and/or audio for an audio recognition model which is updated using the IL without forgetting embodiments of the present disclosure.

Although FIGS. 2 and 3 illustrate examples of devices in a computing system, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication networks, electronic devices and servers can come in a wide variety of configurations, and FIGS. 2 and 3 do not limit the present disclosure to any particular electronic device or server.

Object detection is a fundamental computer vision function that is important for many applications, for example, tracking objects, video surveillance, pedestrian detection, anomaly detection, people counting, self-driving cars, face detection, scene understanding, etc. Life-long learning is useful in object detection because new objects of interest appear continuously and not all data for the new objects is available at the initial training stage. This is because data labeling is costly and, for object detection, both bounding box and category label required. One method for life-long learning is to retrain a new model with all data (old and new). However, data storage cost is a problem, training on large dataset is time-consuming, and life-long learning is not trainable with only new data, due to the problem of catastrophic forgetting.

The present disclosure provides methods for adapting an existing model to implement IL without forgetting for efficient object detection. In the first method, for an object detector model that is fully trained for existing categories or classes of objects, image samples include objects of new categories or classes. In one embodiment, the image samples are fully-labeled with bounding box annotation for each object instance in the image samples. In this first method, while adapting the existing model to the new classes or categories, various embodiments retain the memory of old classes and use the memory to regularize the optimization towards the new classes. In the second method, various embodiments first build a new model for the new classes and then leverage extra unlabeled auxiliary data to combine two models into single compact model. Here, the overall size of the learned model is reduced. At the end of IL with these methods, embodiments of the present disclosure obtain a single adapted model that can detect and/or classify both old and new classes or categories, without requiring access of old training data. While in some embodiments, the old or existing model may be, for example, a RetinaNet model, embodiments of the present disclosure may be used in connection with any other object detectors.

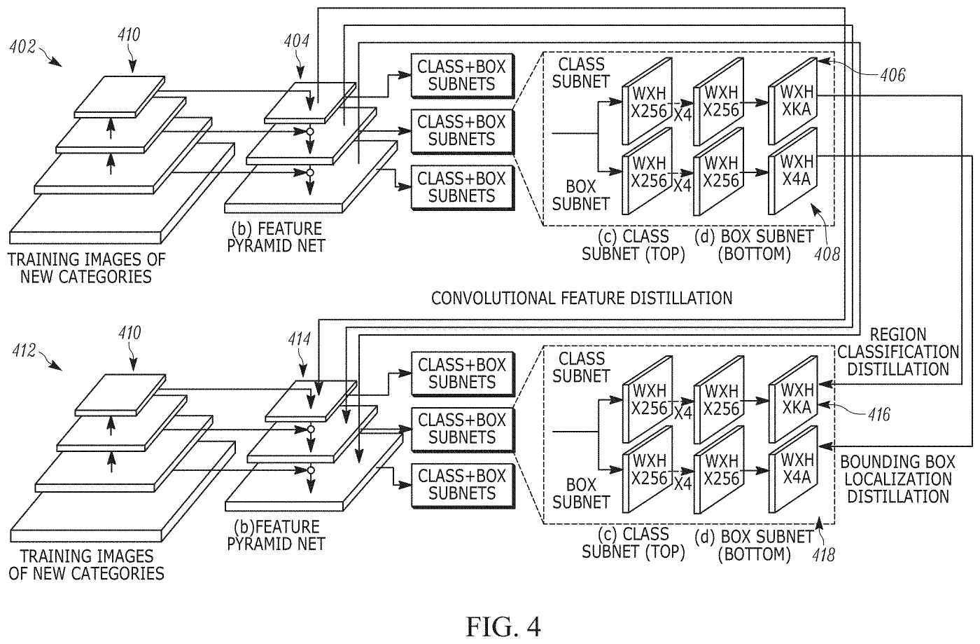

FIG. 4 illustrates an example of a system 400 to implement a method for adapting an existing model to implement IL without forgetting for efficient object detection in accordance with various embodiment of the present disclosure. For example, the system 400 may be implemented by either of the electronic device 200 or 300 in FIG. 2 or FIG. 3. The embodiment of the system 400 is for illustration only. Other embodiments could be used without departing from the scope of the present disclosure.

In this example, an existing detection model 402 (e.g., a RetinaNet object detection model) has been pre-trained on existing classes of objects. Then the system 400 adapts from the existing model 402 an adapted model 412 by initializing parameters from the existing model 402. This adapted model 412 is generated using a training method that makes the adapted model 412 capable of detecting and/or classify both old and new classes, using with labeled images 410 of just the new classes. In some embodiments, the system 400 uses parts of the old data to fine tune the existing model 402, along with the new data. The system 400 summarizes the old data using exemplars, which are representative samples from the old data, as discussed in greater detail below.

In this illustrative example, the existing model 402 utilizes a feature pyramid network (FPN) 404 to extract features from the images 410 which are processed using a set of class networks 406 (shown on top) and a set of bounding box networks 408 (shown on top), where each network in the set of class networks 406 and bounding box networks 408 correspond to the box or class subnet, respectively, associated with a layer in the FPN 404. An FPN is a network to extract features from images using progressively lower resolutions of images at each layer that have progressively higher semantic values. The bounding box networks 408 process the images at the various layers to attempt to detect an object within the image and bound that object with a box with a certain confidence. The class networks 406 process the images at the various layers to attempt to classify or identify a classification or category of the object. Here, the existing model 420 has an equivalent representation of N=(F, B, C), where N is existing model 420, F is FPN 404, B is bounding box networks 408, and C is class networks 406.

The system 400 adapts the existing model 402 into an adapted model 412 that can handle new categories or classes of objects by using the labeled images 410 of new classes or categories to fine-tune the network, with focal loss. Additionally, the system 400 uses a knowledge distillation process to prevent or reduce forgetting knowledge of old classes or categories. This knowledge distillation process optimizes the parameters of the adapted model 412 on the new task with the constraint that the predictions on the new task's examples do not shift much. Using this constraint allows for the adapted model 412 to still remember its old mapping from inputs to output predictions, for the sake of maintaining satisfactory performance on the previous tasks.

To optimize the parameters of the adapted model 412, in one embodiment, the system 400 uses anchor box sampling for the knowledge distillation process. In order to effectively apply region classification distillation and bounding boxes localization distillation, the system 400 uses an anchor boxes sampling method to selectively enforce the constraint for a small set of anchor boxes. An exemplary object detector starts with a regular 2D grid over the image, the resolution of the grid can be multi-level, where higher resolution means the area corresponding image region of each cell in the grid is smaller. There are a set of bounding boxes template with fixed size and aspect ratio, called anchor boxes, are associated with each spatial cell in the grid. Anchor boxes serve as reference boxes for the subsequent prediction. The class label and bounding box location offset relative to the anchor boxes are predicted by the detector. The anchor boxes sampling is to select the anchor boxes that have highest classification confidence scores among all the anchor boxes in the current image.

In these embodiments, the system 400 uses three sources for the knowledge distillation process. As illustrated, the system 400 applies convolutional feature distillation for the intermediate features generated by the FPN 404, in addition to the above discussed classification distillation and bounding boxes localization distillation. The convolutional features are shared by the region classification subnet of class networks 406 and bounding boxes regression subnet of bounding box networks 408. Thus, enforcing stability constraints for the feature representations of the adapted model 414 can greatly reduce catastrophic forgetting for both classification and localization.

In some embodiments, the modifications made to the existing model to provide IL without forgetting are based on a loss function which is outlined below. The below example loss function is provided to satisfying the properties to prevent or reduce catastrophic forgetting:

$$\begin{matrix}\to Loss ( x , {T}_{N} , {T}_{{N}^{′}} ) = {k}_{1} {Loss}_{cross\_entropy} ( x , {T}_{C} ) + & [ a ] \\ {k}_{2} {Loss}_{cross\_entropy} ( {x}_{new} , {c}_{new} , {T}_{{C}^{′}} ) + & [ b ] \\ {k}_{3} {Loss}_{11} ( x , {T}_{B} , {T}_{{B}^{′}} ) + & [ c ] \\ {k}_{4} {Loss}_{11} ( {x}_{new} , {b}_{new} , {T}_{B} , {T}_{{B}^{′}} ) + & [ d ] \\ {k}_{5} {Loss}_{11} ( x , {T}_{F} , {T}_{{F}^{′}} ) & [ e ]\end{matrix}$$

where (x, c, b) are the overall training data tuples (data, class labels, bounding box offsets), (x_{new}, c_{new}, b_{new}) are the new training data tuples, T are parameters of the network components (B, C, F)—F is the o/p layer of the feature pyramid network.

In the loss function, the term [a] is similar to the learning without forgetting (LwF) loss, which attempts to keep the old parameters of C unchanged based on data x, where x can either be the full old data or exemplars. If neither of these are available, new data is used as x. The term [b] is the actual loss function of the new network C′, computed on the new data x using the ground truth classes c. The new term [c] corresponds to network B computes the smooth L₁ loss between the original bounding box offsets and the new bounding box offset vector (4 offset params/box) based on the equation of:

$${Loss}_{l 1} ( x , {T}_{B} , {T}_{{B}^{′}} ) = \{ \begin{matrix}\frac{1}{2} {( Offset ( x , {T}_{B} ) - Offset ( x , {T}_{{B}^{′}} ) )}^{2} , & \vert Offset ( x , {T}_{B} ) - Offset ( x , {T}_{{B}^{′}} ) \vert \leq 1 \\ \vert Offset ( x , {T}_{B} ) - Offset ( x , {T}_{{B}^{′}} ) \vert , & otherwise\end{matrix}$$

for x in the new dataset. The term [d] is the actual loss function of the new network B′, computed on the new data x using the ground truth bounding boxes b. The term [e] is based on a feature term computed over the output of the F network (output layer of the FPN). Here, x can be a combination of the new data and exemplars from the old data

As discussed above, in various embodiments, instead of using only new-class data, the system 400 may retain a few training samples for each existing class (i.e., exemplars) for the adapted model 412. To select the exemplars for each class, the system may use cluster-based exemplar generation for N exemplars per class. For each training sample of the existing model 402, the system 400 extracts feature from FPN 404. For all samples belonging to the same class, the system 400 runs k-means algorithm over the extracted features to generate N clusters. For each cluster, the system 400 then selects the training sample which is the nearest-neighbor of the cluster centroid. This results in N exemplars per class. These exemplars can be retained as a part of the adapted model 412 to avoid the catastrophic forgetting.

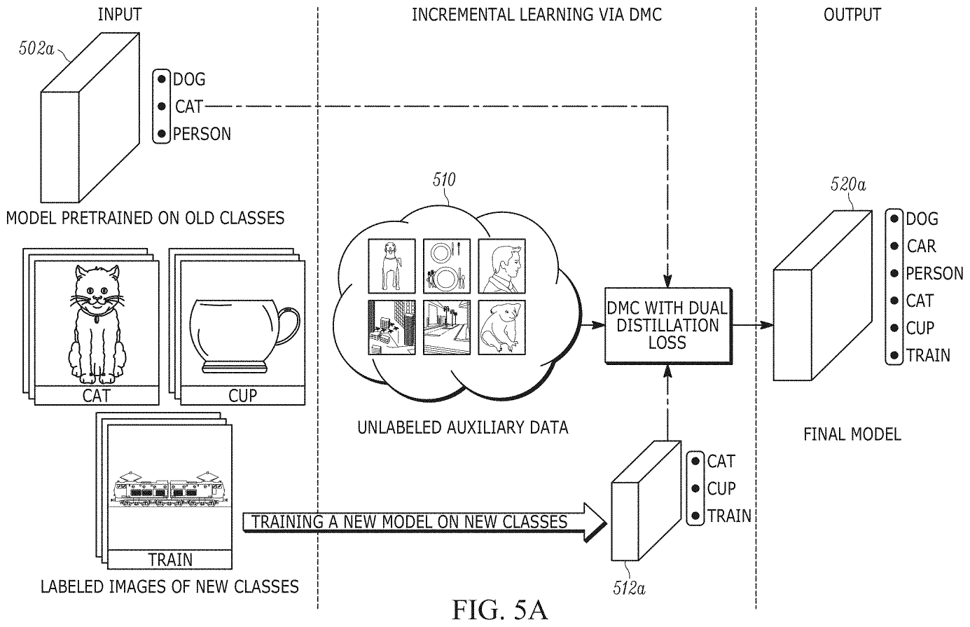

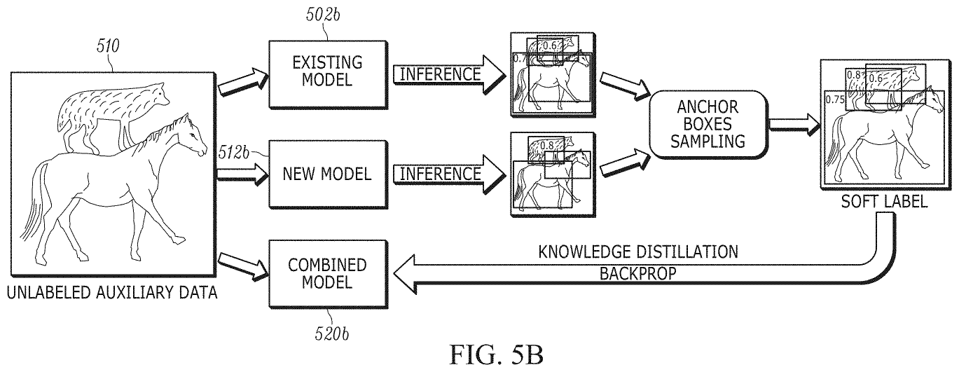

FIGS. 5A and 5B illustrates an example of a diagram of another method for adapting an existing model to implement IL without forgetting for efficient image classification and for efficient object detection in accordance with various embodiments of the present disclosure, respectively. For example, the method may be implemented by either of the electronic device 200 or 300 in FIG. 2 or FIG. 3, generally referred to as the system. As discussed throughout, embodiments of the present disclosure can be applied to either or both of object detection and classification. FIG. 5A provides an illustrative examiner example for image classification and FIG. 5B for object detection. The embodiments of FIGS. 5A and 5B are for illustration only. Other embodiments could be used without departing from the scope of the present disclosure.

As illustrated, the second method for adapting an existing model to implement IL without forgetting includes the system training separate models for existing and new classes and utilizing a consolidation method to combine the existing model 502a and/or 502b and the new model 512a and/or 512b into one single combined model 520a and/or 520b which retains a constant complexity. This IL strategy utilizes both architectural techniques and regularization techniques. In one embodiment, this method includes two stages.

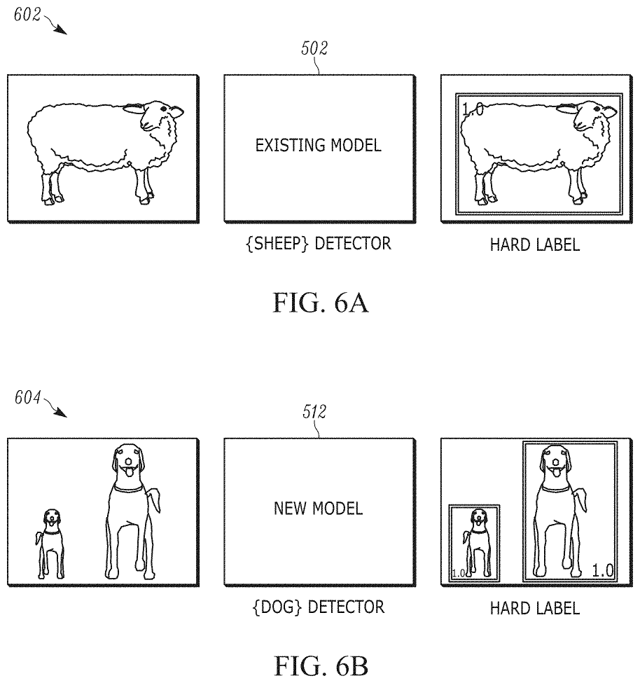

First, the system trains individual detectors for both the existing model 502a and/or 502b and the new model 512a and/or 512b. As illustrated by the example class detectors in FIGS. 6A and 6B, sheep is an old class for the existing model 502a and/or 502b and existing model 502a and/or 502b is pre-trained on this class as detector 602. The example of class detectors in FIGS. 6A and 6B is for illustration only; other embodiments, images, classes, detectors, etc. can be used without departing from the scope of this disclosure. Dog is a new class that is not in the set of classes for the existing model 502a and/or 502b and needs a detector 604 to be trained. The system collects the training samples (or training data) with associated bounding box annotations (e.g., bounded and labeled training data) for the new class. The system applies backpropagation to train new model 512a and/or 512b with region-based classification loss and bounding box regression localization loss. Once the two models 502a and/or 502b and 512a and/or 512b are fully trained, the training data can be discarded.

Next, the system consolidates the two models. The system collects a sufficient number of images (e.g., from the internet) which do not have to be hard labeled. Images in the similar domain of the new classes being added can be beneficial. Then, the system uses the unlabeled auxiliary data 510 to combine the two separate models as illustrated in FIGS. 5A and 5B.

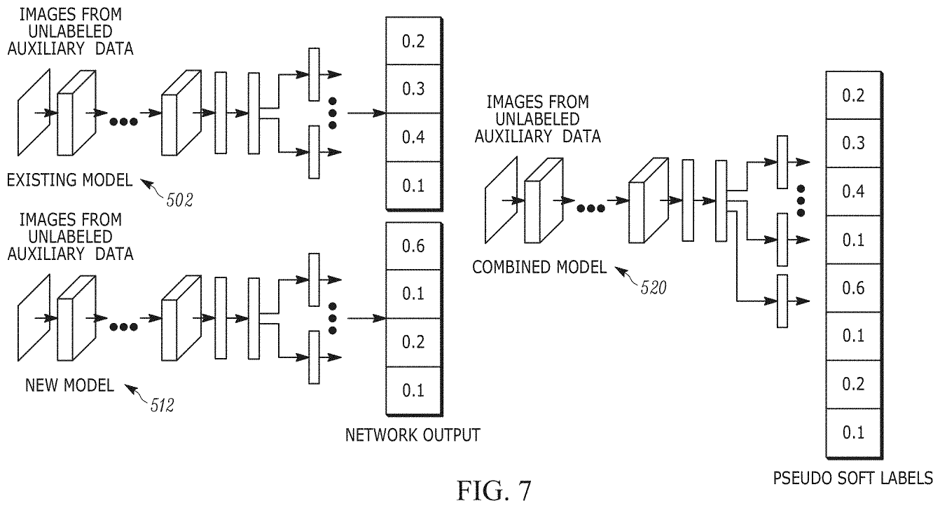

In particular, the system freezes the existing model 502a and/or 502b and new model 512a and/or 512b and instantiate a new instance of a consolidated model, namely combined model 520a and/or 520b. In each training forward pass, the system feeds the images from unlabeled auxiliary data to the existing model 502a and/or 502b and new model 512a and/or 512b and collects the output responses of the two models (e.g., as classification and/or bounding box prediction/confidence scores). These responses include classification prediction and the bounding box localization prediction and can be viewed as pseudo soft labels of the image of the unlabeled auxiliary data. As done in the first method, the system selects a subset of anchor boxes that have the highest classification confidence scores (or sufficiently high enough) among all the anchor boxes and uses the corresponding pseudo soft labels to supervise the training of the combined model 520a and/or 520b. This is illustrated in greater detail in FIG. 7, which is an example diagram for a knowledge distillation process in generating a combined model in accordance with various embodiments of the present disclosure. The example of the knowledge distillation process in FIG. 7 is for illustration only; other embodiments, scores, outputs, labels, etc. can be used without departing from the scope of this disclosure.

The system applies the fully-trained combined model 520a and/or 520b to the images of interest. The combined model 520a and/or 520b is capable of detecting and classifying objects of both old classes and new classes with high accuracy.

According to particular embodiments for the second method, the system performs IL using as deep model consolidation (DMC) for image classification which is extended to object detection. In these embodiments, the system performs the IL in two steps. First, the system trains multiple class classifier using new training data. The second step is to consolidate the existing model 502a and/or 502b and the new model 512a and/or 512b. The new class learning step is a regular supervised learning problem solved by backpropagation.

For DMC for image classification, the system trains a new convolution neural network (CNN) model 512a and/or 512b on new classes using the available training data with standard softmax cross-entropy loss. Once the new model 512a and/or 512b is trained, there are two CNN models, existing model 502a and/or 502b and new model 512a and/or 512b, that are specialized in classifying either the old classes or the new classes. After that, the goal of the consolidation is to have a single compact combined model 520a and/or 520b that can perform the tasks of both the existing model 502a and/or 502b and the new model 512a and/or 512b simultaneously. For example, the output of the combined model may need to approximate a combination of the network outputs of the existing model 502a and/or 502b and the new model 512a and/or 512b. To achieve this, the network response of the existing model 502a and/or 502b and the new model 512a and/or 512b is employed as supervisory signals in joint training of the combined model 520a and/or 520b.

Knowledge distillation is a technique to transfer knowledge from one network to another. In one embodiment, the system uses a knowledge distillation process and a dual distillation loss to enable class-incremental learning. Here, the system defines logits as the inputs to the final softmax layer. The system runs a feed-forward pass of both the existing model 502a and/or 502b and the new model 512a and/or 512b for each training image (unlabeled auxiliary data 510) and collect the logits of the two models. Then, the system minimizes the difference between the logits produced for the combined model 520a and/or 520b and the combination of logits generated by the two existing specialist models 502a and/or 502b and 512a and/or 512b, according to a distance metric. This L2 loss may perform better than binary cross-entropy loss or the original knowledge distillation loss.

For embodiments of consolidation without the legacy or old data used to train the existing model 502a and/or 502b and new model 512a and/or 512b, auxiliary data is used. Based on an assumption that all natural images lie on an ideal low-dimensional manifold, the system can approximate the distribution of the target data via sampling from readily available unlabeled data from a similar domain. This auxiliary data does not have to be stored persistently, the auxiliary data can be crawled (e.g., from the Internet) and fed in mini-batches on-the-fly in the consolidation stage and discarded thereafter.

For DMC for object detection, the system extends the IL approach for image classification for one-stage object detectors, which are nearly as accurate as two-stage detectors but run much faster than the two-stage detectors. A single-stage object detector divides the input image into a fixed-resolution 2D grid (the resolution of the grid can be multi-level), where higher resolution means that the area corresponding to the image region (i.e., receptive field) of each cell in the grid is smaller. There are a set of bounding-box templates with fixed sizes and aspect ratios, called anchor boxes, which are associated with each spatial cell in the grid. Anchor boxes serve as references for the subsequent prediction. The class label and the bounding box location offset relative to the anchor boxes are predicted by the classification subnet (406) and bounding boxes regression subnet (408), respectively, which are shared across all the FPN levels (404).

In order to apply DMC to incrementally train a new object detector for the new model 512a and/or 512b, the system consolidates the classification subnet 516 and bounding boxes regression subnet 518, simultaneously. Similar to the image classification task, the system instantiates a new detector for new training for a new object. After the new detector for the new model 512a and/or 512b is properly trained, the system then uses the outputs of the two models 502a and/or 502b and 512a and/or 512b to supervise the training of the combined model 520a and/or 520b.

In exemplary one-stage object detectors, a huge number of anchor boxes have to be used to achieve decent performance. The time complexity of the forward-backward pass grows linearly with the increase in input image resolution in the consolidation stage. Therefore, selecting a smaller number of anchor boxes speeds up forward-backward pass in training significantly. A standard approach of randomly sampling some anchor boxes does not consider the fact that the ratio of positive anchor boxes and negative ones is highly imbalanced, and negative boxes that correspond to background carry little information for knowledge distillation. In order to efficiently and effectively distill the knowledge of the two teacher detectors in the DMC stage, the system uses an anchor boxes selection method to selectively enforce the constraint for a small set of anchor boxes. For each image sampled from the auxiliary data, the system first ranks the anchor boxes by the objectness scores. The objectness score for an anchor box is defined as the maximum predicted classification probability among all classes (including both the old classes and the new classes). A high objectness a foreground object. The predicted classification probabilities of the old classes are produced by the existing model 502a and/or 502b, and new classes by the new model 512a and/or 512b. The system uses the subset of anchor boxes that have the highest objectness scores and ignores the others.

For consolidation of classification subnets, similar to the image classification discussed above, for each selected anchor box, the system calculates a dual distillation loss between the logits produced by the classification subnet of the combined model 520a and/or 520b and the logits generated by the two existing specialist models 502a and/or 502b and 512a and/or 512b. The loss term of DMC for the classification subnet similar to that discussed above for image classification.

For consolidation of bounding box regression subnets, the output of the bounding box regression subnet are spatial offsets, which specifies a scale-invariant translation and log-space height/width shift relative to an anchor box. For each anchor box selected by our anchor box selection method, the system sets its regression target to the output of either the existing model or the new model. If the class that has the highest predicted class probability is one of the old classes, the system chooses the output of the existing model 502a and/or 502b as the regression target, otherwise, the system chooses the output of the new model 512a and/or 512b. In this way, the system encourages the predicted bounding box of the combined model to be closer to the predicted bounding box of the most probable object class or category. Smooth L1 loss is used to measure the closeness of the parameterized bounding box locations. With consolidation for both image classification and object detection having been completed, the system uses the consolidated parameters in the combined model 520a and/or 520b.

While the above-discussed embodiments involve training a new network for the new classes, the model consolidation techniques of the present disclosure may be applied to more general cases of network consolidation. For example, two models for object detection, N₁=(F₁, B₁, C₁) and N₂=(F₂, B₂, C₂), are independently trained on different data sets and both can do 10-class classification. For example, these two models (N₁ and N₂) could be the existing and new models discussed above and be consolidated to form a combined model (N) as discussed above. Thus, in this example. embodiments of the present disclosure can consolidate the two models into one model N=(F, B, C) that can do 20-classes classification jointly

In this example, the system performs the consolidation with auxiliary unlabeled data. The system obtains auxiliary unlabeled image data, which has a similar distribution as the target data but does not have to contain any instances of the 20 classes. Extending the learning without forgetting techniques discussed above, the system uses N₁ and N₂ as teacher models and N as the student model and trains the student model to mimic the behavior of teacher models on the auxiliary data. In particular, for each selected anchor boxes in an image, the first 10 logit outputs of C should be similar to the logit outputs of C₁; the last 10 logit outputs of C should be similar to the logit outputs of C₂, and the output of B should be similar to B₁ if N₁ gives higher objectness score or B₂ otherwise. As such, the same or similar embodiments for IL discussed above can be applied to network consolidation.

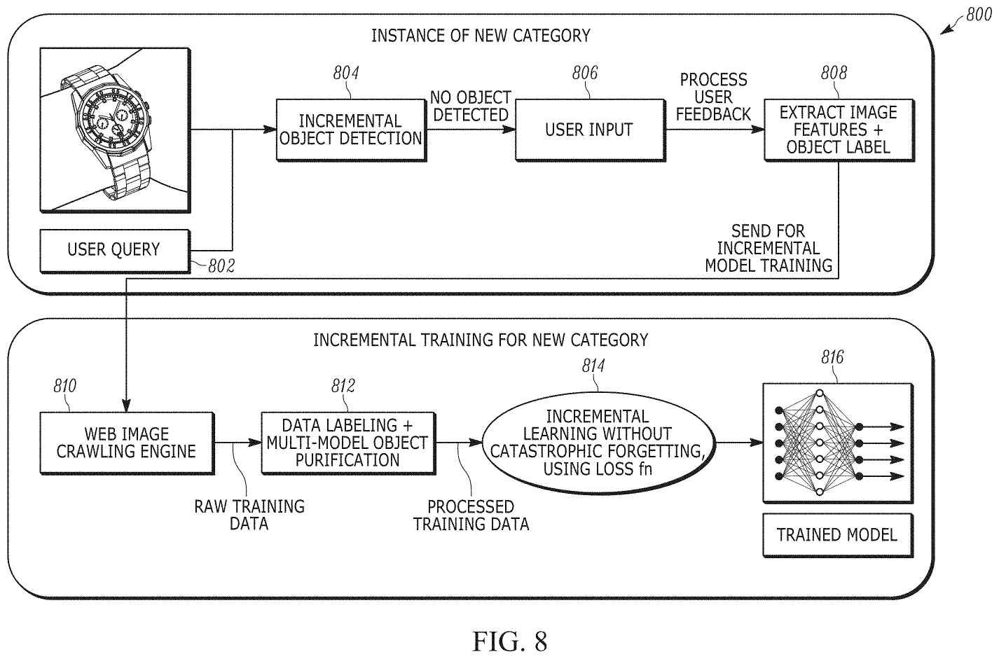

FIG. 8 illustrates a flowchart of a process 800 for an implementation of IL without forgetting in accordance with various embodiments of the present disclosure. For example, the process 800 depicted in FIG. 8 may be performed by the electronic device 200 in FIG. 2 or the electronic device 300 in FIG. 3, respectively, generally referred to here as the system.

In this example, the process begins with an instance of a new category or class of objects. For example, the system may receive an input for user query to identify an object (step 802) (e.g., input from a camera of the electronic device 300 or displayed on display 355). The system then performs incremental object detection (step 804) (e.g., using an existing model 402 or 502a and/or 502b). If being unable to detect the object (e.g., because the object is in a new class), the system requests a user input (step 806) (e.g., a voice or text input into the microphone 320 or the input 350 in FIG. 3) to identify the object. The system then processes the user feedback to extract image features and label the object (step 808).

Thereafter, the system performs incremental training for the new category or class, for example, according to the first or second methods for IL without forgetting as discussed above. The system performs web image crawling (step 810) to extract raw training data. The system then performs data labeling and multi-modal object purification (step 812) to generate processed training data. Thereafter, the system performs incremental learning without catastrophic forgetting, using the loss function (step 814), as discussed above according to either of the methods, to generate an adapted model (step 816) (e.g., adapted model 412 or combined model 520a and/or 520b) that is trained to detect the new class without forgetting the previously trained classes.

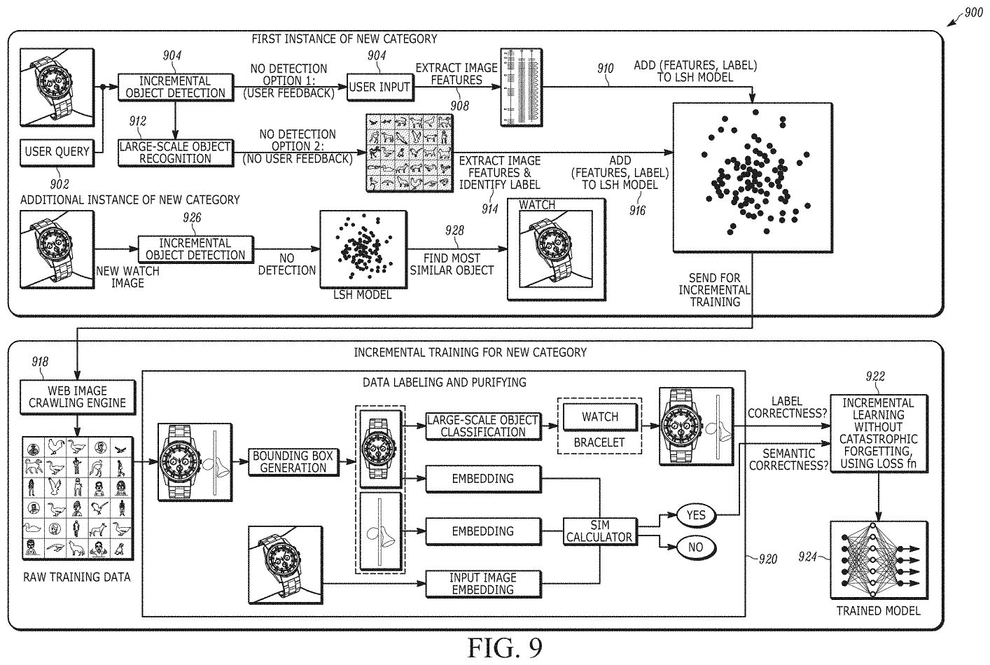

FIG. 9 illustrates a flowchart of a process 900 for another implementation of IL without forgetting in accordance with various embodiments of the present disclosure. For example, the process 900 depicted in FIG. 9 may be performed by the electronic device 200 in FIG. 2 or the electronic device 300 in FIG. 3, respectively, generally referred to here as the system.

In this example, the process begins with an instance of a new category or class of objects. For example, the system may receive an input for user query to identify an object (step 902) (e.g., input from a camera of the electronic device 300 or displayed on display 355). The system then performs incremental object detection (step 904) (e.g., using an existing model 402 or 502a and/or 502b). If being unable to detect the object (e.g., because the object is in a new class), the system has two options depending on whether user feedback is available or desired. If user feedback is available, the system requests and receives a user input (step 906) (e.g., a voice or text input into the microphone 320 or the input 350 in FIG. 3) to identify the object. The system then processes the user feedback to extract image features and label the object (step 908). Thereafter, the system adds the features and label for the object to a locality-sensitive hashing (LSH) model (step 910) and sends the new class for incremental training. If however, no user feedback is available, the system performs large-scale object recognition (step 912) to recognize the object in the image, extracts image features and identifies a label (step 914) for the object, and then adds the features and label for the object to a locality-sensitive hashing (LSH) model (step 916) and sends the new class for incremental training.

Thereafter, the system performs incremental training for the new category or class, for example, according to the first or second methods for IL without forgetting as discussed above. The system performs web image crawling (step 918) to extract raw training data. The system then performs data labeling and purification (step 920) to generate processed training data. For the data labeling and purification, the system performs bounding box generation to detect objects in the training data for large-scale object classification to label the object with an object correctness score (or prediction confidence). Additionally, in the data labeling and purification, the system performs object impeding for a similarity calculation to determine scores for semantic correctness. For example, an image of an object for a new class is provided. The system then trains the new model using the knowledge distillation process by identifying and utilizes feature distillation loss for FPN consolidation, bounding box distillation loss and bounding box regression loss for bounding box network consolidation, and classification distillation loss and classification focal loss for classification network consolidation. In some embodiments, the user-provided label may not match exactly with labels provided in the large-scale classification model.

Thereafter, based on the outputs of the data labeling and purification, the system performs incremental learning without catastrophic forgetting, using the loss function (step 922), as discussed above according to either of the methods, to generate an adapted or trained model (step 924) (e.g., adapted model 412 or combined model 520a and/or 520b) that is trained to detect the new class without forgetting previously trained classes.

For additional instances of new class or category, (e.g., an image of a different watch), the system then performs incremental object detection (step 926) (e.g., using the adapted model). If being unable to detect the object, the system uses the generated LSH model to find a most similar object to label the object.

Although FIGS. 8 and 9 illustrates an example processes for implementations of IL without forgetting, various changes could be made to FIGS. 8 and 9. For example, while shown as a series of steps, various steps in each figure could overlap, occur in parallel, occur in a different order, or occur multiple times.

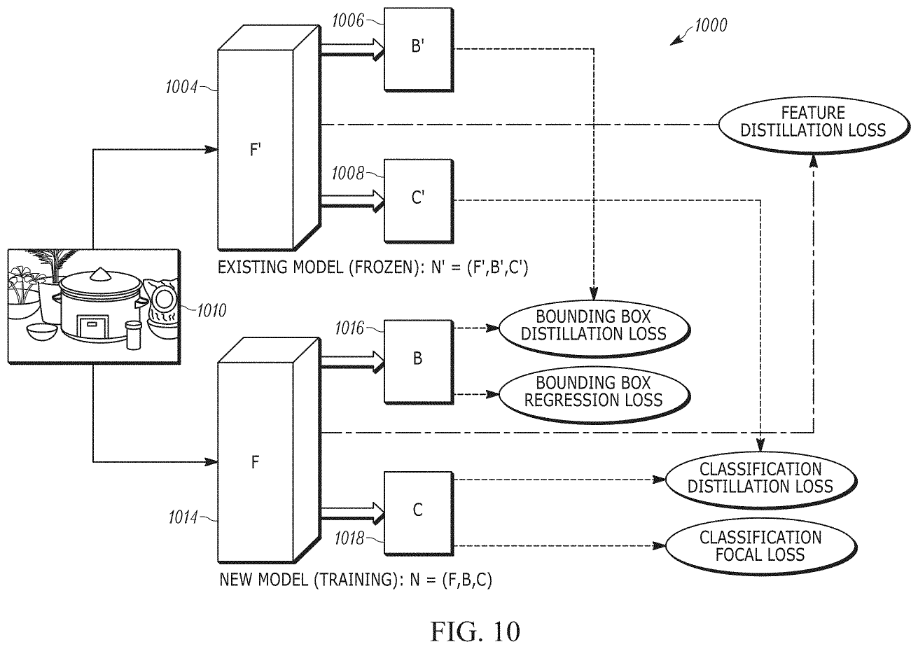

FIG. 10 illustrates an example of a diagram of a system 1000 for adapting an existing model to implement IL without forgetting for efficient object detection in accordance with various embodiment of the present disclosure. For example, in FIG. 10, the system 1000 may use either of the first method for model adaptation for IL without forgetting to perform object detection and/or classification on the image 1010 of the object in a new class. The example of the system 1000 in FIG. 10 is for illustration only. Other embodiments could be used without departing from the scope of the present disclosure.

In this illustrative example, an image 1010 of an object (e.g., a slow cooker) for a new class (e.g., slow cookers) is provided. As discussed above, the existing (frozen) model (including FPN 1004, bounding box network 1006, and classifier network 1008) unsuccessfully attempts detection and classification of the object prompting request of a user label and the creation of the new model (including FPN 1014, bounding box network 1016, and classifier network 1018). The system 1000 then trains the new model by identifying and utilizes feature distillation loss for FPN consolidation, bounding box distillation loss and bounding box regression loss for bounding box network consolidation, and classification distillation loss and classification focal loss for classification network consolidation.

In some embodiments, the user-provided label may not match exactly with labels provided in the large-scale classification model. In one example, the user may have provided the term “slow cooker” as the label whereas labels in the large-scale classification model use the term “crock pot.” Some closely related labels may also be technically correct. For example, the classifier may classify an object a “slow cooker,” “pressure cooker,” or just “cooker.”

To address this labeling problem, in one embodiment, a reasonable assumption-based solution is used if most objects from web crawled images correctly match user's query. This solution involves two steps majority voting and semantic verification. For bounding boxes detected from all crawled web images, a classification model is run to predict the top-5 labels. The top-5 labels from all images form a voting pool. Each label in the voting pool is ranked by the decreasing number of occurrences. The rank-1 label is retained as the correct label. For example, the following pseudo code may be used for identifying the correct label:

```
For rank i in (2, 3, 4 . . . ):
  if count of labelᵢ > threshold && similarity_word2vec(labelᵢ,
  user_query) > threshold:
    retain labelᵢ
  else:
    discard labelᵢ
```

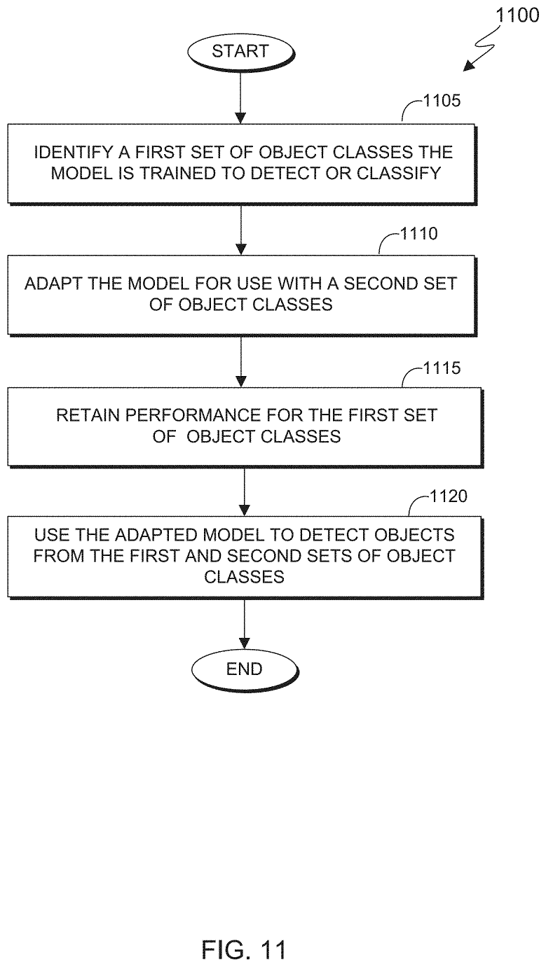

FIG. 11 illustrates a flowchart of a process 1100 for IL in object detection in accordance with various embodiments of the present disclosure. For example, the process depicted in FIG. 11 may be performed by the electronic device 200 in FIG. 2 or the electronic device 300 in FIG. 3, respectively, generally referred to here as the system.

The process begins with the system identifying a first set of object classes the model is trained to detect or classify (step 1105). For example, in step 1105, the system may have an existing model (e.g., existing model 402 or 502a and/or 502b) that is trained to perform object detection and classification.

The system then adapts the model for use with a second set of object classes (step 1110). For example, in step 1110, the system may receive a request to detect and classify an object that is in new class that is different from the first set of object classes.

In various embodiments, according to the first method for IL as part of this step, adapting the model for use with the second set of object classes may be the system modifying the existing model to detect the new classes to generate the adapted model 412. For example, as discussed above, the system may train the existing model to detect new classes using labeled training images of the new classes.

In various embodiments, as part of this step according to the second method for IL, adapting the model for use with the second set of object classes may be the system generating a second model to detect the second set of object classes using a labeled set of data for the second set of object classes and then combining the first model and the second model using an unlabeled set of auxiliary data to generate the adapted model. In this example, the adapted model may be a combined such as combined model 520a and/or 520b. Here, the system may combine the first model and the second model by performing object detection on the unlabeled set of auxiliary data using the first and second models to generate a first and second sets of model outputs (e.g., classification scores, prediction confidences and/or the network outputs), respectively, and combine the model based on a loss function (e.g., the loss function discussed in connection with FIG. 4 above or the dual distillation loss) using the first and second sets of classification scores.

In one example, the system may receive a request to identify an object, in response to being unable to identify the object based on the model, request an input to label the object, label the object based on the input, and adapt (using either of the methods for IL) the model for use with the second set of object classes where the labeled object is one of the object classes in the second set. Additionally, the system may search for additional instances of objects in the object class of the labeled object, and adapt the model by training the model using the additional instances of the objects in the object class of the labeled object.

Thereafter, the system retains detection or classification performance for the first set of object classes (step 1115). For example, in step 1115, the system may perform a knowledge distillation process, as discussed above, to retain the performance for the old classes. This knowledge distillation process may include distilling feature, bounding box, and/or classification loss from among the old and adapted (or new) models to retain the performance on the old object classes. In some embodiments, the system may retain the exemplars of the old or first classes to allow for IL in the adapted model but without forgetting the original classes. As part of this step, the system may retain to parameters to discourage changes of output for the first set of object classes in the adapted model may include the system extracting a feature for each of a plurality of training samples for the first set of object classes in the model; generating, for a set of the training samples belonging to a same class in the first set of object classes, N clusters based on the extracted features; for each of the N clusters, selecting a training sample from the set of training samples that is a nearest-neighbor of a cluster centroid; and retaining performance for the first set of object classes.

In some embodiments, the system interactively selects the best model using the following method. The system receives a training time upper limit and other information, for example, from a user, and uses the received information to determine best number of training epochs. In one embodiment, the system is given the training time upper limit “t” and other information, e.g., the GPU model, training data availability, model size, and network bandwidth etc. The system then determines the number of epochs to use to train for the model using the formula:

$${num}_{epochs} = t -- {size}_{mode} \times {speed}_{download} - {time}_{{construct}_{{training}_{set}}} / GPU\_time \_per \_epoch$$

Considering the trade-off between accuracy and time, the system considers two hyper-parameters on which the performance the system mainly depends (a) the number of web-crawled training images and (b) the number of iterations for the algorithm. For (a) the number of images, in one embodiment, the system collects about 100 images for the new class. It is observed that this number is a good sweet spot in accuracy/time tradeoff but it is possible to use less examples (e.g. 50) to improve speed. For (b) number of training iterations, in one embodiment, number of iterations is fixed (between 5-10). The system may measure the training loss and stop the training iterations when the loss is smaller than a threshold. For example, the system may use a very small validation set and select the number of training iterations by using a threshold on validation loss/accuracy to avoid overfitting.

The system then uses the adapted model to detect objects from the first and second sets of object classes (step 1120). For example, in step 1120, the system may use the adapted model to perform object detection and/or object classification.

While object detection may be used as an example, in any of these embodiments, the system may perform object detection or image classification. Additionally, while various embodiments relate to image object detection or classification, the IL methods of the present disclosure may be applied to other types of detection or classification. In one example, the IL methods of the present disclosure may be applied to perform speech and/or audio recognition and/or classification to recognize words, verbal command, speech patterns, etc.

Although FIG. 11 illustrates an example processes for IL in object detection, various changes could be made to FIG. 11. For example, while shown as a series of steps, various steps in each figure could overlap, occur in parallel, occur in a different order, or occur multiple times.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the applicants to refer to structures known to those skilled in the relevant art and is not intended to invoke 35 U.S.C. § 112(f).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for incremental learning, the method comprising:
identifying, via a model for object detection or classification, a first set of object classes the model is trained to detect or classify;
adapting the model for use with a second set of object classes different from the first set of object classes to generate an adapted model;
retaining detection or classification performance on the first set of object classes in the adapted model by performing a knowledge distillation process for the model; and
using the adapted model to detect or classify one or more objects from the first set of object classes and one or more objects from the second set of object classes.

2. The method of claim 1, wherein the model is a first model and adapting the first model for use with the second set of object classes different from the first set of object classes comprises:
generating a second model to detect or classify the second set of object classes using a labeled set of data for the second set of object classes; and
combining the first model and the second model using an unlabeled set of auxiliary data to generate the adapted model.

3. The method of claim 2, wherein combining the first model and the second model to generate the adapted model using the unlabeled set of auxiliary data comprises:
performing object detection or classification on the unlabeled set of auxiliary data using the first model to generate a first set of model outputs;
performing object detection or classification on the unlabeled set of auxiliary data using the second model to generate a second set of model outputs; and
combining the first model and the second model based on a loss function using the first and second sets of model outputs.

4. The method of claim 1, wherein retaining the detection or classification performance on the first set of object classes in the adapted model comprises:
extracting a feature for each of a plurality of training samples for the first set of object classes in the model;
generating, for a set of the training samples belonging to a same class in the first set of object classes, N clusters based on the extracted features;
for each of the N clusters, selecting a training sample from the set of training samples that is a nearest-neighbor of a cluster centroid; and
retaining the detection or classification performance on the first set of object classes.

5. The method of claim 1, further comprising:
in response to being unable to identify an object from the second set of object classes based on the model, receiving a label of the object,
wherein adapting the model for use with the second set of object classes to generate the adapted model comprises adapting the model for use with the second set of object classes, the labeled object being one of the object classes in the second set.

6. The method of claim 5, further comprising:
searching for additional instances of objects in the object class of the labeled object based on the label,
wherein adapting the model for use with the second set of object classes further comprises training the model using the additional instances of the objects.

7. The method of claim 1, further comprising using the adapted model to perform object classification.

8. An electronic device for incremental learning, the electronic device comprising:
a memory configured to store a model for object detection or classification; and
a processor operably connected to the memory, the processor configured to:
identify, via the model for object detection or classification, a first set of object classes the model is trained to detect or classification;
adapt the model for use with a second set of object classes different from the first set of object classes to generate an adapted model;
retain detection or classification performance on the first set of object classes in the adapted model by performing a knowledge distillation process for the model; and
use the adapted model to detect or classify one or more objects from the first set of object classes and one or more objects from the second set of object classes.

9. The electronic device of claim 8, wherein the model is a first model and to adapt the first model for use with the second set of object classes different from the first set of object classes, the processor is further configured to:
generate a second model to detect or classify the second set of object classes using a labeled set of data for the second set of object classes; and
combine the first model and the second model using an unlabeled set of auxiliary data to generate the adapted model.

10. The electronic device of claim 9, wherein to combine the first model and the second model to generate the adapted model using the unlabeled set of auxiliary data, the processor is further configured to:
perform object detection or classification on the unlabeled set of auxiliary data using the first model to generate a first set of model outputs;
perform object detection on the unlabeled set of auxiliary data using the second model to generate a second set of model outputs; and
combine the first model and the second model based on a loss function using the first and second sets of model outputs.

11. The electronic device of claim 8, wherein to retain the detection or classification performance on the first set of object classes in the adapted model, the processor is further configured to:
extract a feature for each of a plurality of training samples for the first set of object classes in the model;
generate, for a set of the training samples belonging to a same class in the first set of object classes, N clusters based on the extracted features;
for each of the N clusters, select a training sample from the set of training samples that is a nearest-neighbor of a cluster centroid; and
retain the detection or classification performance on the first set of object classes.

12. The electronic device of claim 8, wherein the processor is further configured to:
in response to being unable to identify an object from the second set of object classes based on the model, receive a label of the object,
wherein to adapt the model for use with the second set of object classes to generate the adapted model, the processor is further configured to adapt the model for use with the second set of object classes, the labeled object being one of the object classes in the second set.

13. The electronic device of claim 12, wherein:
the processor is further configured to search for additional instances of objects in the object class of the labeled object based on the label, and
to adapt the model for use with the second set of object classes, the processor is further configured to train the model using the additional instances of the objects in the object class of the labeled object.

14. The electronic device of claim 8, wherein the processor is further configured to use the adapted model to perform object classification.

15. A non-transitory, computer-readable medium comprising program code for incremental learning that, when executed by a processor of an electronic device, causes the electronic device to:
identify, via a model for object detection or classification, a first set of object classes the model is trained to detect or classify;
adapt the model for use with a second set of object classes different from the first set of object classes to generate an adapted model;
retain detection or classification performance on the first set of object classes in the adapted model by performing a knowledge distillation process for the model; and
use the adapted model to detect or classify one or more objects from the first set of object classes and one or more objects from the second set of object classes.

16. The non-transitory, computer-readable medium of claim 15, wherein the model is a first model and the program code that, when executed, causes the electronic device to adapt the first model for use with the second set of object classes different from the first set of object classes, comprises program code that, when executed by the processor, causes the electronic device to:
generate a second model to detect or classify the second set of object classes using a labeled set of data for the second set of object classes; and
combine the first model and the second model using an unlabeled set of auxiliary data to generate the adapted model.

17. The non-transitory, computer-readable medium of claim 16, wherein the program code that, when executed, causes the electronic device to combine the first model and the second model to generate the adapted model using the unlabeled set of auxiliary data, comprises program code that, when executed by the processor, causes the electronic device to:
perform object detection or classification on the unlabeled set of auxiliary data using the first model to generate a first set of model outputs;
perform object detection or classification on the unlabeled set of auxiliary data using the second model to generate a second set of model outputs; and
combine the first model and the second model based on a loss function using the first and second sets of model outputs.

18. The non-transitory, computer-readable medium of claim 15, wherein the program code that, when executed, causes the electronic device to retain the detection or classification performance on the first set of object classes in the adapted model, comprises program code that, when executed by the processor, causes the electronic device to:
extract a feature for each of a plurality of training samples for the first set of object classes in the model;
generate, for a set of the training samples belonging to a same class in the first set of object classes, N clusters based on the extracted features;
for each of the N clusters, select a training sample from the set of training samples that is a nearest-neighbor of a cluster centroid; and
retain the detection or classification performance on the first set of object classes.

19. The non-transitory, computer-readable medium of claim 15, further comprising program code that, when executed by the processor, causes the electronic device to:
in response to being unable to identify an object from the second set of object classes based on the model, receive a label of the object,
wherein the program code that, when executed, causes the electronic device to adapt the model for use with the second set of object classes to generate the adapted model, comprises program code that, when executed by the processor, causes the electronic device to adapt the model for use with the second set of object classes, the labeled object being one of the object classes in the second set. j

20. The non-transitory, computer-readable medium of claim 19, further comprising program code that, when executed by the processor, causes the electronic device to:
search for additional instances of objects in the object class of the labeled object based on the label,
wherein the program code that, when executed, causes the electronic device to adapt the model for use with the second set of object classes, comprises program code that, when executed by the processor, causes the electronic device to train the model using the additional instances of the objects in the object class of the labeled object.
